(19) United States
(12) Patent Application Publication
(10) Pub. No.: US 2020/0311745 A1
(43) Pub. Date: Oct. 1, 2020

(54) PERSONALIZE AND OPTIMIZE DECISION PARAMETERS USING HETEROGENEOUS EFFECTS

(71) Applicant: Microsoft Technology Licensing, LLC, Redmond, CA (US)

(72) Inventors: Ye Tu, San Carlos, CA (US); Kinjal Basu, Sunnyvale, CA (US); Jinyun Yan, Sunnyvale, CA (US); Shaunak Chatterjee, Sunnyvale, CA (US); Birjodh S. Tiwana, Dublin, CA (US)

(21) Appl. No.: 16/370,224

(22) Filed: Mar. 29, 2019

(51) Int. Cl. G06Q 30/02; G06N 5/02; G06N 7/00

(52) U.S. Cl. CPC G06Q 30/02; G06N 7/005; G06N 5/022

(57) ABSTRACT

Technologies for optimizing content delivery to end-users are provided. Disclosed techniques include storing results of an online experiment with respect to a set of users and determining a plurality of distinct subsets of users based upon the results of the experiment. Users within each of the plurality of distinct subsets may be identified based on metric impacts of the online experiment. For each distinct subset and each associated model parameter, a utility value that represents effectiveness of the model parameter, with respect to an objective, may be determined. An objective optimization model may be used to automatically determine probabilities for each of the model parameters associated with each distinct subset. Users of a second set of users may be assigned to a distinct subset and associated model parameters may be applied to a content delivery strategies of the second set of users.

### TECHNICAL FIELD

The present disclosure relates to identifying distinct subsets of users based on online session interaction data and optimizing presentation of content to users based on their association with the distinct subsets, and more specifically, to computer software that analyzes user information, including session interaction data, to identify the distinct subsets of users and optimizes content delivery to users based on the properties of the distinct subsets of users.

### BACKGROUND

Content delivery optimization techniques may benefit content delivery platforms by helping platforms determine how to optimize delivery of content to users in order to promote desired objectives of the content delivery platform. Content delivery strategies may include the frequency in which notifications of new content are sent to users, what time of day sent notifications of new content result in user engagement, and determining which content should be displayed within a user's feed in order to promote a desired outcome. Content delivery optimization may be based on several factors such as a user's network of contacts, frequency that a user opens a new session, average length of a session, and many other user interaction metrics.

However, determining the most effective delivery strategy remains a challenge. Optimizing based upon similar demographics of users may lead to better a desired outcome for some users but not others, as not all user preferences may be defined by pre-selected demographic information. Other strategies may optimize content delivery on a per user basis, using historical interaction data specific to each user. However, customizing content delivery on a per user basis may require significant computing resources to calculate optimal delivery strategies and historical data for each user may not include a large enough sample size to accurately predict preferred optimization strategies. Therefore optimization strategies that determine groups of users based on historical user interaction behavior may be preferred to determine user groups and how to optimize content delivery for the groups of users.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for determining distinct subsets of users of a plurality of end-users and optimizing objective-based content delivery to the plurality of end-users, in an embodiment.

FIG. 2 depicts an example embodiment of a portion of a generated causal tree with leaf nodes representing distinct subsets of users, in an embodiment.

FIGS. 3A and 3B depict example flowcharts for determining distinct subsets of users and optimizing content delivery to the distinct subsets of users based upon one or more delivery objectives, in an embodiment.

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

As disclosed herein, optimization of content delivery may be useful for improving the user online experience by determining optimal times, frequency, placement, and selection of content to present to users. Content presentation optimization is improved by adding technology that implements a particular approach of performing online experiments to test various content delivery strategies in order to identify distinct subsets of users based upon the online experiments. Upon determining the distinct subsets of users, output from the online experiments may be analyzed to determine optimal content presentation strategies for users based upon their assignment to a distinct subset of users. One particular approach may perform and store results of an online experiment with respect to a set of users. A plurality of distinct subsets for a set of users may be identified from the results of the online experiment. The set of users may represent a subset of a plurality of users that consume content. The online experiment may represent a series of tests where one or more treatment approaches are applied to the set of users. For instance, different frequencies of notification delivery may be applied to the set of users, where a random group users may receive notifications at one particular frequency, another random group of users may receive notifications at another particular frequency, and yet another random group of users may receive notifications at a control frequency. Different configurations of content delivery and properties associated with users receiving various treatment approaches may be represented by a plurality of model parameters.

Based on the results of the online experiment, a plurality of distinct subsets of users may be identified, where each distinct subset of users has an associated number of model parameters. For each distinct subset and for each model parameter associated with each subset, a utility value may be determined, where the utility value represents an average causal effect for a particular treatment represented by a model parameter versus an effect of a control value for a specific subset of users. For example, a particular utility value may represent the average causal effect of applying notification frequency X to a subset of users versus the effect of applying a control notification frequency to the subset of users. Each of the utility values for each of the model parameters determined for each of the subsets of users may be stored within a data repository.

One particular approach may implement a stochastic optimization model to automatically determine probabilities for each model parameter of the plurality of model parameters for each distinct subset of users based upon their respective utility values in order to maximize a particular objective. For instance, if one objective to be maximized is initiating new user sessions, then probabilities may be determined for each distinct subset of users based upon utility values associated with model parameters related to generating new user sessions.

The distinct subsets of users determined may be used to classify other users based upon the model parameters associated with each of the distinct subsets of users. Each second user of a second set of users within the plurality of users may be assigned to a particular distinct subset based upon aligning properties of each respective user to properties associated with the distinct subsets of users. Upon identifying a particular distinct subset to which a user belongs, a plurality of probabilities that are associated with the particular distinct subset may be identified. Based upon the identified probabilities, one or more model parameters of the plurality of model parameters may be identified and assigned to each second user assigned to the particular distinct sub set.

The disclosed approaches provide advantages over conventional solutions by determining the distinct subsets of users based upon observed user interactions and user properties. That is, users may be associated with particular distinct subsets of users based upon their interaction behaviors, thus providing a more accurate grouping of users based upon observed behaviors, rather than assigning users to groups based upon predetermined groups of users. The disclosed approaches provide further optimization of content presentation based upon the determined subsets of users and observed metrics for each of the users within their respective subsets of users. By optimizing how and when content is presented to users on a distinct subset by distinct subset basis, effectiveness of content presentation for an objective may be improved.

### System Overview

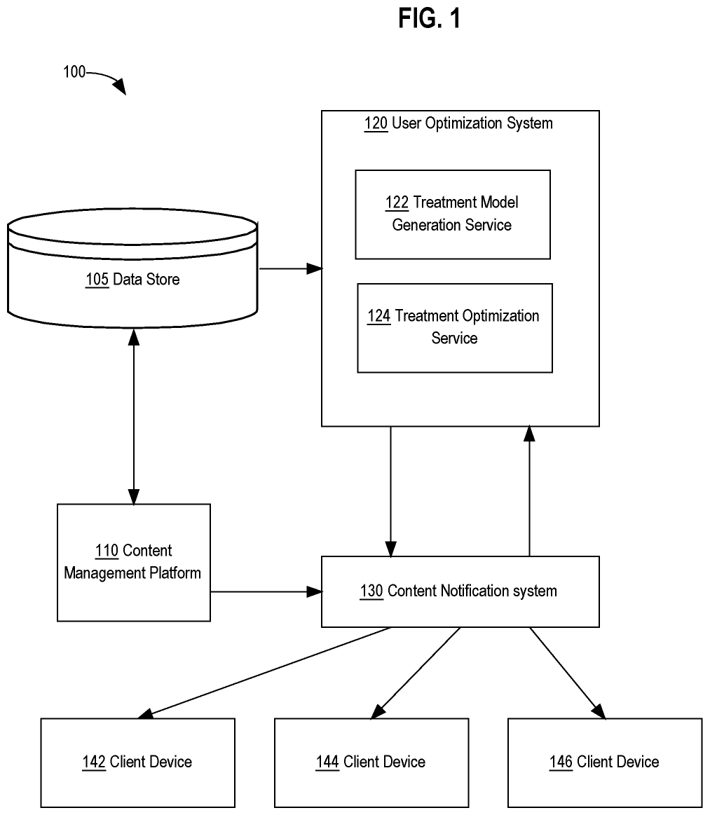

FIG. 1 is a block diagram that depicts a system 100 for determining distinct subsets of users of a plurality of end-users and optimizing objective-based content delivery to the plurality of end-users. System 100 may represent a content platform that includes a data store 105, a content management platform 110, user optimization system 120, a content notification system 130, and client devices 142-146. Although a single content management platform is depicted, system 100 may include additional content management platforms. Similarly, system 100 may include additional content item notification systems.

In an embodiment, the content management platform 110 may be one or more computing devices (such as a rackmount server, a router computer, a server computer, a personal computer, a mainframe computer, a laptop computer, a tablet computer, a network connected television, a desktop computer, etc.), data stores (e.g., hard disks, memories, databases), networks, software components, and/or hardware components that may be used to provide a user with access to content items and/or provide the content items to the user. For example, the content management platform 110 may allow a user to consume, upload, search for, approve of (e.g. “like”), dislike, and/or comment on content items.

Examples of a content items may include, but are not limited to, messages, articles, media such as pictures, video, and sound clips, invitations to connect, and any other event or object that may be consumed by a user. A user session may refer to a period of activity between when a user logs into the content platform and the user logs out of the content platform. For example, Jane Smith may initiate a user session by logging into the content platform. Jane Smith may visit several pages, and then end her user session by logging out or by not interacting with the content platform for a period of time.

In an embodiment, the content management platform 110 may track user sessions and store related user session metrics in the data store 105. User session metrics may include, but are not limited to, time and date of the user session, the user who initiated the user session, the duration of the user session, number of actions performed and number of pages visited during the user session, and user specific metrics describing the number and type of content items available for consumption prior to initiating the user session. In an embodiment, the content management platform 110 may also generate user-specific aggregated metrics that describe metrics related to user sessions initiated by specific entities. For example, the content management platform 110 may generate aggregated metrics that describe an average daily number of page views for Jane Smith, a daily average number of available content items in Jane Smith's feed, an average duration of entity sessions for Jane Smith, and any other metric that may be aggregated for the user Jane Smith.

In an embodiment, the content management platform 110 may determine how and when specific content items are presented to users. For example, the content management platform 110 may adjust which content items are presented in a user's feed and may adjust how content items are ranked for presentation to users based upon optimization strategies provided by the user optimization system 120. For example, if the user optimization system 120 optimizes content presentation for maximizing the average duration of user sessions, then the content management platform 110 may adjust which content items are presented within a user's feed and/or how content items are ordered for presentation within the user's feed.

In an embodiment, the data store 105 may represent data storage that stores user profile data related to users, user session metrics, and aggregated user session metrics. User profile data may include, but is not limited to, user job titles, user experience, a user's network connections, education data, and geo-location history. User session metrics may include user interaction history of user sessions. The stored data may be accessed by the content management platform 110 and the user optimization system 120.

In an embodiment, the content notification system 130 generates notification messages for users and sends the notification messages to client devices 142-146 for corresponding users. The content notification system 130 may receive a request, from the content management platform 110, that contains one or more pending content items that are available for consumption by a target user. For example, if the target user has 8 new content items in their content item feed, then the content management platform 110 may send a request to generate a notification to the content notification system 130.

In an embodiment, client devices 142-146 may represent computing devices including, but not limited to, desktop computers, laptop computers, tablet computers, wearable devices, video game consoles, and smartphones. Client devices 142-146 may represent devices users may use to receive notifications and initiate new user sessions.

### User Optimization

In an embodiment, the user optimization system 120 may optimize content presentation to users based on different types of objectives. For example, the user optimization system 120 may optimize content presentation to users in order to maximize the total number of user sessions or the user optimization system 120 may optimize content delivery for maximizing the total number of widgets presented to users. The user optimization system 120 optimizes content presentation by analyzing user interactions captured from one or more online experiments. The online experiments may be experiments tailored to apply different content presentation strategies to a set of users and capture user interactions in order to determine whether the content presentation strategies result in better optimization for a particular objective. The user optimization system 120 may analyze the output of the online experiments to determine distinct subsets of users based upon user interactions within the online experiments and user profile properties of users participating in the online experiments. Upon determining the distinct subsets of users, the user optimization system 120 may optimize content presentation strategies specific to each of the distinct subsets of users based upon desired objectives. The user optimization system 120 may comprise a treatment model generation service 122 and a treatment optimization service 124.

### Model Generation from Experiments

In an embodiment, the treatment model generation service 122 generates a data model for measuring treatment effects from online experiments and determining distinct subsets of users based upon observed outcomes from the online experiments. The treatment model generation service 122 may generate the data model from observed interaction data and user profile information for a set of users that were part of one or more online experiments. In an embodiment, the online experiments may represent multiple different types of A/B testing. An A/B test is a randomized experiment with two variants, A and B. A/B testing is one way of comparing applied values of a single variable and observing responses from users. For example, if an A/B test is configured to test whether sending notifications at a frequency of every hour versus every two hours, then the A/B test may apply one hour notification treatment to a set of users and apply the two hour notification treatment to another set of users. Outcomes of whether the one hour or two hour notification treatment resulted in a higher number of new user sessions may be observed. In other examples, multivariate testing may be applied to test several different treatment levels, including a control treatment which may represent the current notification frequency of the content notification system 130. User interactions from the online experiments may be stored within the data store 105.

In an embodiment, the treatment model generation service 122 implements a causal tree algorithm, as described by Ye Tu, et al., https://arxiv.org/pdf/1901.10550.pdf, to estimate heterogeneity in causal effects of applying different treatments to a set of users. A causal tree is a type of decision tree where distinct groups of users, represented by leaf nodes, are grouped based upon user profile properties and historical user behavior. Users are grouped into distinct groups based upon observable properties and user reactions and/or effects of the A/B tests . For example, one distinct subset of users, based upon their observable properties and the A/B test results, may prefer a high frequency of content notifications. Another distinct subset of users, based upon their observable properties and the A/B test results, may prefer a lower frequency of content notifications. In other embodiments, the treatment model generation service 122 may generate other types of models such as regression trees. For example the treatment model generation service 122 may implement Bayesian additive regression trees as described by Hugh Chipman, et al., https://arxiv.org/pdf/0806.3286.pdf.

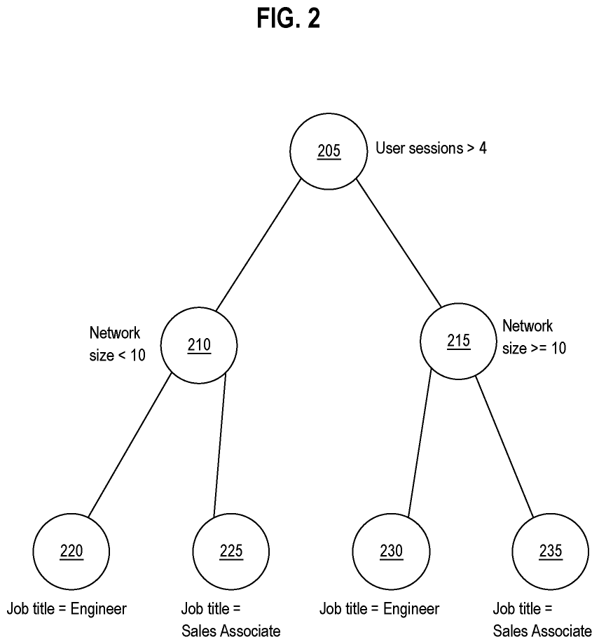

In an embodiment, the treatment model generation service 122 may generate nodes of the causal tree using based upon historical user properties and historical interaction data of users. The historical interaction data may refer to captured user interactions and statistics derived from the user interactions, where the user interactions are observed interactions prior to the A/B tests. The observed interactions may be stored within the data store 105, as training data. FIG. 2 depicts an example embodiment of a portion of a generated causal tree with leaf nodes representing distinct subsets of users. Each of the nodes may represent one or more user properties based on past user activity prior to performing the online experiment. Node 205 may represent a set of users that have been identified by their past activity as having initiated greater than 4 user sessions in a week. Nodes 210 and 215 are child nodes of node 205. Node 210 represents a subset of users from node 205 that have a user network size less than 10 and have initiated greater than 4 user sessions in a week. Node 215 represents a different subset of users from node 205 that have a user network size greater than or equal to 10 and have initiated greater than 4 user sessions in a week. Nodes 220 and 225 are child nodes of node 210. Node 220 represents a subset of users from node 210 that were identified as having a job title matching “engineer”, having a user network size less than 10, and having initiated greater than 4 user sessions in a week. Node 225 represents another subset of users from node 210 that were identified as having a job title matching “sales associate”, having a user network size less than 10, and having initiated greater than 4 user sessions in a week. Nodes 230 and 235 are child nodes of node 215. Node 230 represents a subset of users from node 215 that were identified as having a job title matching “engineer”, having a user network size greater than or equal to 10, and having initiated greater than 4 user sessions in a week. Node 235 represents a subset of users from node 215 that were identified as having a job title matching “sales associate”, having a user network size greater than or equal to 10, and having initiated greater than 4 user sessions in a week. Nodes 220, 225, 230, and 235 each represent leaf nodes and may represent distinct subsets of users. Each of the distinct subsets of users are heterogeneous subsets as the property values associated with each distinct subset are unique to that distinct subset. In embodiments, identified distinct subsets of users may be based on a different number property types and different property values. For instance, distinct subsets of users may be based on more or less observed interaction types. In embodiment, users within each distinct subset of users may have been assigned different treatment levels, including control being as a control treatment. For example, the subset of users represented by node 220 may include users that were given different levels of treatment during the online experiment.

The treatment model generation service 122 may generate nodes of the causal tree by implementing a node splitting algorithm that determines how to generate child nodes of a particular node by analyzing user profile properties and/or user interaction observations to determine heterogeneous subsets of users. Each heterogeneous subset of users from the users of their parent node may comprise a set of users for each child node generated. In an embodiment, the treatment model generation service 122 may determine heterogeneous subsets of users by evaluating a mean square error of a difference between a group of users that received a treatment, Y₁, and another group of users that received a control, Y₀, from the online experiment. In an embodiment, the delta effects between treatment and control groups may be represented as, τ=Yᵢ(treatment=1)−Yᵢ(treatment=0). As each user in the online experiment may only receive either a treatment or a control, τ may be estimated based on conditional average treatment effects of users in the same leaf node, l, as:

[symbol]

=τₗ= [symbol] (Y₁ₗ)− [symbol] (Y₀ₗ), where i∈l

In an embodiment, the treatment model generation service 122 may minimize leaf level variance by implementing an honest estimation procedure to partition data into separate training, estimation, and cross validation test datasets (S^{tr}, S^{est}, S^{cv}, with dataset sizes of N^{tr}, N^{est}, N^{cv} respectively). The treatment model generation service 122 may implement the following tree splitting algorithm in order to estimate the mean square error of the delta effect, τ, between treatment and control groups as:

$${EMSE}_{τ} ( {S}^{tr} , {N}^{est} , Π , α ) = α * 1 / {2}^{tr} {\sum }_{i ∈ {S}^{t r}} {\hat{τ}}^{2} ( {X}_{i} ; {S}^{tr} , Π ) - ( 1 - α ) * ( 1 / {N}^{tr} + 1 / {2}^{est} ) {\sum }_{l ∈ \prod } ( \frac{{σ}_{{S}^{t r} treat}^{2} ( l )}{p} + \frac{{σ}_{{S}^{t r} control}^{2} ( l )}{( 1 - p )} )$$

where:
EMSE_{τ}(S^{tr}, N^{est}, Π, α) is an estimated mean square error of training data, S^{tr}, with an estimated size of N^{est}. The treatment model generation service 122 may use distinct datasets, including, but not limited to, a training data set “tr” and an estimated dataset “est”.
Π represents the distinct subsets of users.
α is a hyperparameter that may be tuned to adjust weight between the mean square error and the sum of leaf variance.
τ=Yᵢ(treatment=1)−Yᵢ(treatment=0), such that τ is an estimate of the delta between treatment and control groups.
N^{tr} is the size of the training data.
\hat{τ} is an estimate of the conditional average treatment effects of units in the same leaf, l.
p is the percentage of records in treatment out of the total number of records, for each leaf.

In an embodiment, the treatment model generation service 122 may apply various node generation constraints on the causal tree in order to ensure identified subsets of users are not too granular. For example, the treatment model generation service 122 may define a minimum number of users for each node in order to prevent identifying nodes with distinct subsets of users that only contain a few or even one user. Having many small subsets of users may result in erroneous optimization strategies based upon small sample sizes for the small subsets of users. In an embodiment, the treatment model generation service 122 may use one or more hyperparameters to define minimum sizes of nodes within the causal tree.

The node splitting algorithm may be used to determine the nodes of the causal tree. Once the nodes are determined, the causal tree may be cross validated using cross validation data as:

$${EMSE}_{τ} ( {S}^{tr , cv} , {N}^{est} , Π , α ) = α * 1 / {N}^{tr , cv} {\sum }_{i ∈ {S}^{tr , cv}} {\hat{τ}}^{2} ( {X}_{i} ; {S}^{tr , cv} , Π ) - ( 1 - α ) * ( 1 / {N}^{tr , cv} + 1 / {N}^{est} ) {\sum }_{l ∈ Π} ( {S}_{{S}^{tr , cv} treat}^{2} l / p + {S}_{{S}^{tr , cv} control}^{2} l / ( 1 - p ) )$$

where S^{tr,cv} and N^{tr,cv} represent cross validation data and the size of the cross validation data, respectively. S^{tr,cv} data is part of the training dataset and is used for cross validation.

In an embodiment, the treatment model generation service 122 may analyze the leaf nodes of the causal tree to determine an output of distinct subsets of users, where each leaf node represents one distinct subset of users. Each distinct subset of users may have one or more associated user properties based upon user profile information and historical interaction data and one or more model parameters. The associated model parameters may refer to system parameters used during the online experiments, such as model thresholds or one or more treatment values for one or more applied treatments of the online experiments and/or weighted parameters in a multi-objective optimization function. In an embodiment, each distinct subset of users may represent one or more user properties. For example referring to FIG. 2, a first distinct subset of users may be represented by node 220, which represents users that have a job title of engineer, have a user network size less than 10, and have initiated greater than 4 user sessions in a week. Node 230 may represent a second distinct subset of users that have a job title of sales associate, have a user network size greater than or equal to 10, and have initiated greater than 4 user sessions in a week.

The treatment model generation service 122 is able to use the node splitting algorithm to generate nodes of the causal tree based upon user properties and historical user interaction data captured prior to performance of the online experiments. The generated causal tree may be used to estimate the causal effects of metrics of interest using data generated from the online experiment (e.g. A/B test). By allowing the user-observed data to define the subsets of users, the content notification system 130 may more effectively optimize delivery of content to users based upon a desired objective.

### Optimizing Subsets of Users Based on a Desired Objective

Upon identifying the heterogeneous subsets of users based upon a causal tree model, the treatment optimization service 124 may determine, for each model parameter associated with users of each distinct subset of users, probabilities of achieving a desired objective using assigned model parameter values of a distinct subset of users. A model parameter value represents an amount of treatment applied to users, for instance the model parameter value may specify thresholds for sending notifications to users or any other treatment type threshold.

In an embodiment, for each distinct subset of users, the treatment optimization service 124 may estimate a utility value for each model parameter value of a particular treatment type. The utility value may represent an effect of the particular treatment type using a particular model parameter value versus applying a control treatment. If the objective is maximizing user sessions per week and the model parameter value specifies a threshold for determining when to send notifications to users, then the utility value for the particular treatment type with the particular model parameter value may represent a delta value of the observed number of new sessions for the distinct subset of users minus the observed number of new sessions from a distinct subset of users that received a control treatment. For example, if the distinct subset of users that received the particular treatment type with the particular model parameter value had an observed number of 5 new user sessions per week and the distinct subset of users that received the control treatment had an observed number of 2 new user sessions per week, then the utility value of the particular treatment type with the particular model parameter value would equal 3 new user sessions per week (5 sessions per week−2 sessions per week).

In an embodiment, utility values for distinct subsets of users may be calculated for each model parameter value used within the online experiment. Utility value, Uᵢⱼ may represent the utility value for subset of users “i” that were given model parameter value “j”. The following table illustrates example utility values for the distinct subset of users C₁:

| Parameter value (j) | |
|---|---|
| for treatment type | Utility value (U) |
| j = 1 | 2 |
| j = 2 | 4 |
| j = 3 | 3 |
| j = 4 | 6 |

where the utility value units may represent any configured unit of measurement.

In an embodiment, the treatment optimization service 124 may determine utility values for each parameter value, j, for each of the distinct subsets of users represented by C₁, C₂ . . . C_{N}, where N equals the total number of identified subsets of users by the treatment model generation service 122. For example, the treatment optimization service 124 may generate a set of utility values Uᵢⱼ, where “i” is the distinct subset of users from 1 to N, and “j” is the model parameter value for the particular treatment type from 1 to M, where M is the total number of different model parameter values. The treatment optimization service 124 may store the calculated utility values within the data store 105.

In an embodiment, the treatment optimization service 124 may implement a stochastic optimization algorithm to determine probabilities of achieving the desired objective for each of the calculated utility values for each of the distinct subsets of users. Stochastic optimization refers to method for minimizing or maximizing an objective function defined on a subset of finite dimensional space. The data set used to determine the distinct subsets of users and their corresponding utility values is based upon a subset of the plurality of users within the content management system 110. Therefore, based on the limited data set size used in the online experiment, each of the utility values carry a variance that may skew estimations of probabilities of specific treatments. In order to minimize skewed estimations, the treatment optimization service 124 may implement a stochastic optimization algorithm with gradient descent that accounts for provided constraints. Examples of constraints may include limits on the number of notifications sent to users, limiting the type of content presented to users, or any other constraint that may limit the number and/or type of content presented. For example, if the objective is maximizing the number of new sessions for users, then the constraint may be a limit on the total number of notifications sent to users by the content notification system 130. In another example, if the objective is maximizing the number of widgets presented, then a constraint may be disabling content notifications for certain types of widgets.

In an embodiment, the treatment optimization service 124 may determine probabilities for each distinct subset of users, Cᵢ, where different model parameter values ranging from T₁-T_{M} have been applied and observed for users within the distinct subset of users Cᵢ. The probabilities may be denoted as xᵢⱼ∈[0,1], where j represents the j^{th} model parameter value treatment and i represents the i^{th} distinct subset of users from the plurality of distinct subsets of users. The sum of the probabilities of the different j model parameter value treatments applied to the i^{th} distinct subset of users equals 1, such that:

$${\sum }_{i , j} {x}_{i , j} {U}_{i , j}^{m} \geq {c}_{m} for all m = 2 , … , M$$

where xᵢⱼ is the probability for the j^{th} model parameter value given to the i^{th} distinct subset of users. U_{i,j}^{m} represents the utility value for the j^{th} model parameter value given to the i^{th} distinct subset of users. The cₘ represents a specific constraint applied.

In an embodiment, the stochastic algorithm may be used to define optimization as an expectation function, for maximizing ƒ(x)=E(x^{T}U⁰), where x^{T} is a transpose vector of probabilities and U⁰ is a vector of the utility values. The expectation function may be expanded to account for constraints as:

gₘ(x)=E(x^{T}U^{m}−cₘ)≥0 for all m=2, . . . ,M

In an embodiment, minimizing ƒ(x)=E(F(x, U¹)) may be expressed as:

gₘ(x)=E(Gₘ(x,U^{m}))≤0 for all m=2, . . . ,M

In an embodiment, the treatment optimization service 124 may implement a gradient descent to solve for an optimal probability, x*, for each of the utility values. To solve for x*, a probability x₁ may be selected as a random probability from the set of probabilities X based on thresholds {ηₖ} and {γₖ}. The treatment optimization service 124 may iterate the following calculations for N steps, where k=[1, . . . , N]. At each step, the constraint function may be estimated as:

$$= \frac{1}{J} {\sum }_{j = 1}^{J} {G}_{m} ( {x}_{k} , {U}_{j}^{m} )$$

where [symbol] is an estimator of Gₘ(x, U^{m}).

If the estimated constraints [symbol] are less than or equal to a threshold ηₖ, then the gradient chosen to be the stochastic gradient of the objective function is:

hₖ=F′(xₖ,Uₖ¹)

If however, the estimated constraints [symbol] are greater than threshold ηₖ, then the gradient chosen to be the stochastic gradient of the objective function is:

hₖ=G′_{m*}(xₖ,Uₖ^{m*})

where m*∈{m| [symbol] >ηₖ} is chosen at random. After choosing the gradient, the treatment optimization service 124 applies the following proximal mapping function to determine the next point xₖ₊₁ as: xₖ₊₁=Pₓ_{ₖ}_{,X}(γₖhₖ).

The treatment optimization service 124 may the define the optimal probability x* as:

x*=(Σ_{k∈B}γₖ)⁻¹(Σ_{k∈B}γₖxₖ)

where B={s≤k≤N| [symbol] ≤ηₖ for all m}.

In an embodiment, each of the calculated probabilities, x, for each of the utilities, U, may be stored within the data store 105.

### Process Overview

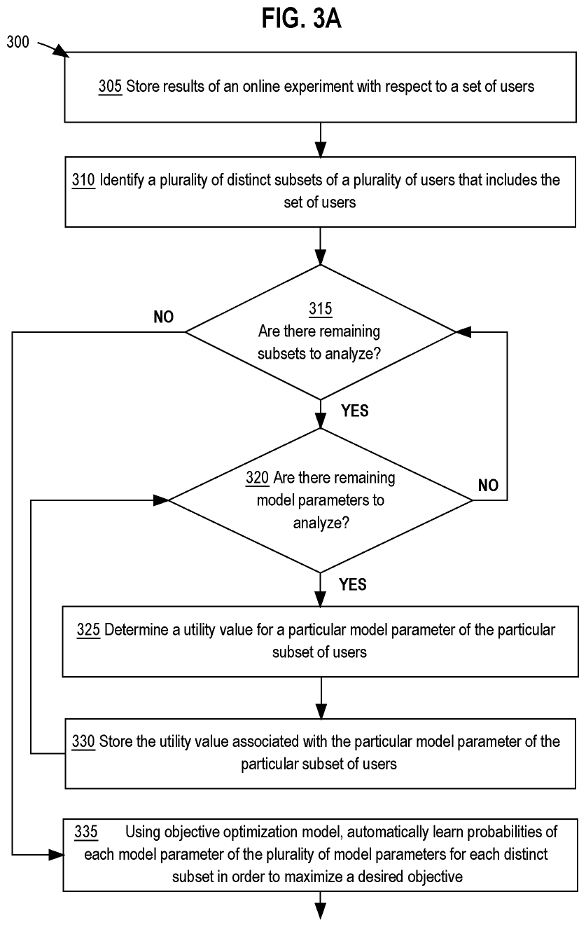

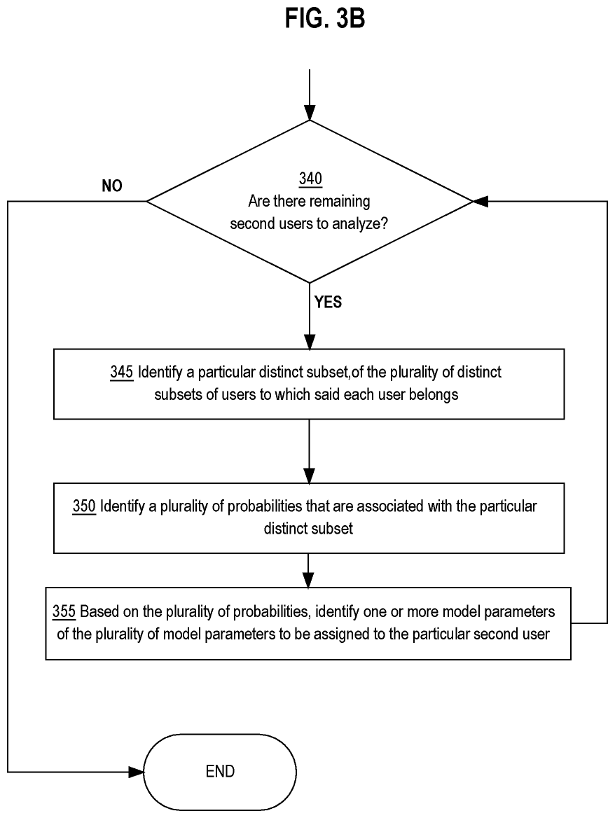

FIGS. 3A and 3B depict an example flowchart for determining distinct subsets of users and optimizing content delivery to the distinct subsets of users based upon one or more delivery objectives. Process 300 may be performed by a single program of multiple programs. The operations of the process as shown in FIGS. 3A and 3B may be implemented using processor-executable instructions that are stored in computer memory. For purposes of providing a clear example, the operations of FIGS. 3A and 3B are described as performed by components of system 100. For the purposes of clarity process 300 is described in terms of a single entity.

In an embodiment, one or more online experiments are performed by the content management platform 110. The content management platform 110 may conduct online experiments, such as A/B tests or other multivariate tests, on a set of users in order to test different treatments types and different treatment values on the set of users. Each of the different treatment types may include model parameter values that specify different levels of treatment and a control value, where the control value may equal the current prescribed treatment given to the plurality of users using the content management system 110. For example, an online test may be performed to test different frequencies of sending a notification. Different model parameter values may specify different thresholds for sending notifications to users. For instance a first model parameter value may specify sending notifications to users when a user has 5 new content items in their feed. A second model parameter value may specify sending notifications to users when a user has 2 new content items in their feed. A control model parameter value may specify the current notification rules for a general population of users, which may specify sending a notification when a user has 10 new content items in their feed. In another embodiment, an external service may run the one or more online experiments and the content management platform 110 may have access to the results of the online experiment.

In operation 305, process 300 stores results of an online experiment with respect to a set of users. In an embodiment, the content management platform 110 may store results of the online experiment in the data store 105. Results may include the set of users, user interactions of the set of users during the online experiment, and user profile properties associated with each of the users of the set of users.

In operation 310, process 300 identifies a plurality of distinct subsets of a plurality of users that includes the set of users involved in the online experiment. In an embodiment, the treatment model generation service 122 may access the results from the data store 105 and use the set of users from the online experiment as training data to generate a causal tree. Nodes of the causal tree may represent heterogeneous subsets of the users from the online experiment. The heterogeneity may be based on user profile properties of the users and historical user interactions and behaviors captured prior to conducting the online experiment and. In an embodiment, the treatment model generation service 122 may implement the node splitting algorithm to determine an estimated mean square error of the delta effects between treatment and control groups, τᵢ=Y₁ᵢ−Y₀ᵢ, where Y₁ᵢ represents the treatment group and Y₀ᵢ represents the control group of the online experiment.

Upon generating the nodes of the causal tree, the treatment model generation service 122 may identify leaf nodes from the causal tree, where subset of users associated with leaf nodes make up the distinct subsets of users. For example referring to FIG. 2, leaf node 230 may have an associated subset of users that is identified as having a user network size greater than or equal to 10, having initiated greater than 4 user sessions in a week, and as having a job title matching engineer. Other subsets of users associated with other leaf nodes, such as nodes 220, 225, and 235, may be identified by their user interaction behavior and user profile properties defined by the leaf node. The treatment model generation service 122 may output a set of the distinct subsets of users. For instance, the output may be represented by the set {C₁, C₂, . . . C_{N}}, where C represents a distinct subset of users and N represents the total number of subsets identified from the causal tree.

In decision diamond 315, process 300 may determine whether there are remaining distinct subsets of users to analyze to determine utility values for each of the model parameters. In an embodiment, the treatment optimization service 124 may receive the distinct subsets of users from the treatment model generation service 122 and may determine utility values for each of the model parameters associated with each of the distinct subset of users. If there are remaining subsets of users to analyze, then process 300 may select a particular subset of users from the distinct subsets of users and proceed to decision diamond 320 to evaluate each of the model parameters for the particular subset of users selected. If, however, there are no remaining subsets of users to analyze, then process 300 may proceed to operation 335 to determine probabilities for each model parameter, for each distinct subset of users.

In decision diamond 320, process 300 may determine whether there are remaining model parameters, of the plurality of model parameters associated with the particular subset of users, to be analyzed. In an embodiment, the treatment optimization service 124 may iteratively analyze each model parameter of the plurality of model parameters associated with the particular subset of users selected. If there are remaining model parameters to analyze, then process 300 may select a particular model parameter and proceed to operation 325 to determine a utility value for the particular model parameter selected. If, however, at decision diamond 320 the treatment optimization service 124 determines that there are no remaining model parameters associated with the particular subset of users to be analyzed, then process 300 may proceed to decision diamond 315 to evaluate another distinct subset of users from the distinct subsets of users.

In operation 325, process 300 determines a utility value for the particular model parameter of the particular subset of users. In an embodiment, the treatment optimization service 124 estimates a utility value for the particular model parameter being analyzed. The utility value may represent an effect of the treatment type using the particular model parameter value versus applying a control treatment. For example, if the objective is to maximize the number of new sessions for users of the subset of users, the utility value for the treatment type with the particular model parameter value may represent a delta value of the observed number of new sessions initiated by users of the subset of users minus the observed number of new sessions initiated by users of a second subset of users, where the second subset of users received the control treatment. If the observed number of new sessions for the users of the subset of users equals 20 and the observed number of new sessions for the users of the second subset of users equals 15, then the utility value, defined as the delta value, would be 5 (20 sessions−15 sessions).

In operations 330, process 300 stores the utility value associated with the particular model parameter of the particular subset of users. In an embodiment, the treatment optimization service 124 may store the determined utility value for the particular model parameter of the particular subset of users within the data store 105. Upon completing operation 330, process 300 may return to decision diamond 320 to determine whether there are remaining model parameters for the particular subset of users to analyze. If there are remaining model parameters to analyze for the particular subset of users, then process 300 may select the next model parameter and proceed to operation 325. If at decision diamond 320, process 300 determines that there are no more remaining model parameters to analyze, then process 300 may proceed back to decision diamond 315 to determine whether there are remaining subsets of users to process.

If, at decision diamond 315, process 300 determines that there are no more remaining subsets of users to process, then process 300 proceeds to operation 335. In operation 335, process 300 uses an objective optimization model to automatically learn probabilities of each model parameter of the plurality of model parameters for each of the distinct subsets of users in order to maximize a desired objective. In an embodiment, the treatment optimization service 124 may iteratively analyze each of the associated model parameters of each of the distinct subsets of users, using the stochastic optimization algorithm with gradient descent, to determine probabilities associated with the model parameters with respect to the desired objective.

In an embodiment, each of the determined probabilities associated with the model parameters for each of the distinct subsets of users may be stored in the data store 105. The distinct subsets of users, including the probability values for each of the model parameter values, may be used to assign treatments with model parameter values to other users based upon which distinct subset of users the other users belong. The treatment optimization service 124 may determine treatment options for other users of the content management system 110 that were not part of the online experiment. Other users may be referred to as a second set of users and may represent either a subset of the plurality of users or the remaining plurality of users. In an embodiment, the treatment optimization service 124 may iterate through each of the second users of the second set of users to identify a distinct subset of users to which each second user belongs, and identify one or more model parameters to assign to each of the second users.

Referring to FIG. 3B, in decision diamond 340, process 300 may determine whether there are remaining second users of the second subset of users to analyze for model parameter assignment. In an embodiment, the treatment optimization service 124 may determine whether there are additional second users to analyze. If there are remaining second users to analyze, then the treatment optimization service 124 may select a particular second user of the remaining second users of the second subset of users and proceed to operation 345. If, however, there are no remaining second users of the second subset of users to analyze, then process 300 may end.

In operation 345, process 300 identifies a particular distinct subset of users from the plurality of distinct subsets of users to which the second user belongs. In an embodiment, the treatment optimization service 124 may analyze and compare user profile properties and historical user interactions within the content management platform 110 of the particular second user to associate model parameters and user profile properties of each of the distinct subsets of users to determine which distinct subset of users aligns with the properties of the second user. For example, if the second user has associated user interaction behavior that indicates that the second user, on average, generates greater than 4 user sessions, has a network size that is less than 10, and has user profile properties that align with the users associated with node 220, then the treatment optimization service 124 may identify the subset of users associated with node 220.

In operation 350, process 300 identifies a plurality of probabilities associated with the particular distinct subset of users. In an embodiment, the treatment optimization service 124, upon identifying the particular distinct subset of users to which the particular second user belongs, may access the data store 105 to retrieve a plurality of model parameters associated with the particular distinct subset of users. For example, if the data store 105 contained a set of model parameters [P₁, P₂, . . . P_{N}] for the particular distinct subset of users, where P is a model parameter value and N is the total number of model parameters associated with the particular subset of users. The treatment optimization service 124 may then access, from the data store 105, the probabilities associated with the retrieved plurality of model parameters. For instance, the treatment optimization service 124 may access associated probabilities for each of the model parameters [P₁, P₂, . . . P_{N}]. The result set from the data store 105 may be represented as [(P₁, x₁), (P₂, x₂), . . . (P_{N}, x_{N})], where x is the probability for the corresponding model parameter P.

In operation 355, process 300 identifies one or more model parameters of the plurality of model parameters to be assigned to the particular second user based upon the plurality of probabilities. Associated probabilities define a probability of achieving the desired objective with the model parameter value applied to the particular second user. For instance, if a first model parameter value specifies a frequency of notification delivery as being three per hour and the first model parameter has an associated probability of 60% then the desired objective may be satisfied 60% of the time when the first model parameter is applied to the particular second user. That is, the treatment optimization service 124 may determine to apply either one model parameter, multiple model parameters, or all of the model parameters to the particular second user based upon the probabilities associated with each model parameter.

In an embodiment, the treatment optimization service 124 may assign a single model parameter to the particular second user if the single model parameter is above a particular probability threshold. The particular probability threshold may define when the probability of a single model parameter represents a large majority of the total probabilities for the plurality of model parameters associated to the particular subset of users. For instance, if the particular probability threshold is 90% and if the probability of the first model parameter is above 90%, then the treatment optimization service 124 may assign the first model parameter to the particular second user as the first model parameter yields an above 90% probability that the treatment will result in achieving the desired objective.

In another embodiment, the treatment optimization service 124 may assign multiple model parameters to the particular second user if the multiple model parameters are above a minimum threshold. The minimum threshold may define a minimum probability value for model parameters that make it beneficial to assigning the model parameter to the particular second user. Probability values, such as 5% or 10%, may not be worthwhile to assign to a user because a 5% probability value means that 5% of the time the corresponding model parameter value will achieve the desired objective for the particular second user. Therefore, the minimum threshold may be used to define the lowest probability value that is worthwhile to assign to a user for achieving the desired objective. For example, if the minimum threshold is set to 25% and if one or more model parameter values have probabilities above 25%, then the treatment optimization service 124 may assign the one or more model parameter values to the particular second user.

In yet another embodiment, the treatment optimization service 124 may assign each of the model parameter values to the particular second user if each of the probabilities of each of the model parameters is close in value and/or are above the minimum threshold. For example, if there are 5 model parameter values that each have a probability of 20% then the treatment optimization service 124 use any one of the 5 model parameter values by assigning each of the model parameter values to the particular second user. In an embodiment, if multiple model parameter values are assigned to a user, then the content management platform 110 may be configured to select one of the multiple model parameters for the user. For example, the content management platform 110 may randomly select one of the multiple model parameters using the associated probability value as a weighted factor in determining which model parameter value to select. In other examples, the content management platform 110 may cycle through each of the multiple model parameters, or may implement any other selection algorithm.

Upon performing operation 355, process 300 may proceed back to decision diamond 340 to determine whether there are remaining second users of the second subset of users to analyze for model parameter assignment. If there are remaining second users, then process 300 may proceed to operations 345-355 to analyze model parameters for the remaining second users. If, however, there are no remaining second users, then process 300 may end.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

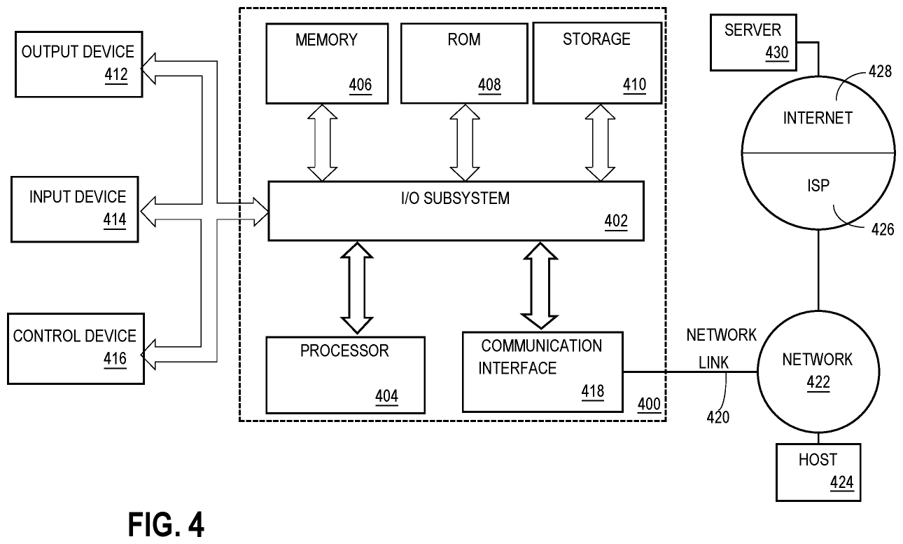

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing results of an online experiment with respect to a set of users, the online experiment comprising a plurality of model parameters;
based on the results of the online experiment, identifying a plurality of distinct subsets of a plurality of users that includes the set of users;
for each distinct subset of the plurality of distinct subsets:
for each model parameter of the plurality of model parameters:
determining a utility value of said each model parameter with respect to said each distinct subset;
storing the utility value in association with said each distinct subset;
using an objective optimization model, automatically determining probabilities of each model parameter of the plurality of model parameters for each distinct subset in order to maximize a particular objective;
for each second user in a second set of users in the plurality of users:
identifying a particular distinct subset, of the plurality of distinct subsets, to which said each second user belongs;
identifying a plurality of probabilities that are associated with the particular distinct subset;
based on the plurality of probabilities, identifying one or more model parameters of the plurality of model parameters to be assigned to said each second user; and
wherein the method is performed by one or more computing devices.

2. The method of claim 1, wherein the plurality model parameters comprise one or more treatment values for one or more treatments of the online experiment.

3. The method of claim 1, wherein identifying the plurality of distinct subsets of the plurality of users that includes the set of users, comprises:
generating a tree data structure comprising a set of nodes that represents subsets of users of the set of users, wherein each node is based upon values of one or more model parameters of the plurality of model parameters; and
identifying the plurality of distinct subsets as a set of leaf nodes of the tree data structure.

4. The method of claim 3, wherein each leaf node of the set of leaf nodes contains a minimum number of users of the set of users.

5. The method of claim 3, wherein generating the tree data structure comprises:
for each node within the tree data structure, determining whether to generate two or more child nodes of the respective node based upon a mean square error value of a difference of an outcome of a group of users receiving a treatment and an outcome of another group of users receiving a control; and
upon determining to generate the two or more child nodes, generating the two or more child nodes based upon a value of the particular model parameter, wherein each of the two or more child nodes represents a subset of the subset of users assigned to the respective node based upon the value of the particular model parameter associated with the respective child node.

6. The method of claim 1, wherein each distinct subset of the plurality of distinct subsets of the plurality of users is associated with distinct user properties describing at least one of a user profile property and user interaction behavior.

7. The method of claim 1, wherein the objective optimization model is a stochastic optimization model configured to determine probabilities of model parameters for each distinct subset given model constraints.

8. The method of claim 1, wherein identifying the one or more model parameters of the plurality of model parameters to be applied to said each second user, comprises:
determining that a particular model parameter of the plurality of model parameters has an associated probability of the plurality of probabilities that is above a probability threshold; and
assigning, to said each second user, the particular model parameter based upon the associated probability being above the probability threshold.

9. The method of claim 1, wherein identifying one or more model parameters of the plurality of model parameters to be applied to said each second user, comprises:
determining that probabilities associated with each of the plurality of model parameters is below a probability threshold; and
assigning, to said each second user, a subset of model parameters of the plurality of model parameters, wherein each model parameter of the subset of model parameters is above a minimum probability threshold.

10. The method of claim 1, wherein the one or more model parameters of the plurality of model parameters to be applied to said each user is related to configuring thresholds of at least one of: frequency of notification delivery or selection of feed content.

11. A system comprising:
one or more computer processors;
a content platform coupled to the one or more processors, wherein the content platform performs operations comprising:
storing results of an online experiment with respect to a set of users, the online experiment comprising a plurality of model parameters;
based on the results of the online experiment, identifying a plurality of distinct subsets of a plurality of users that includes the set of users;
for each distinct subset of the plurality of distinct subsets:
for each model parameter of the plurality of model parameters:
determining a utility value of said each model parameter with respect to said each distinct subset;
storing the utility value in association with said each distinct subset;
using an objective optimization model, automatically determining probabilities of each model parameter of the plurality of model parameters for each distinct subset in order to maximize a particular objective;
for each second user in a second set of users in the plurality of users:
identifying a particular distinct subset, of the plurality of distinct subsets, to which said each second user belongs;
identifying a plurality of probabilities that are associated with the particular distinct subset;
based on the plurality of probabilities, identifying one or more model parameters of the plurality of model parameters to be assigned to said each second user.

12. The system of claim 11, wherein the plurality model parameters comprise one or more treatment values for one or more treatments of the online experiment.

13. The system of claim 11, wherein identifying the plurality of distinct subsets of the plurality of users that includes the set of users, comprises:
generating a tree data structure comprising a set of nodes that represents subsets of users of the set of users, wherein each node is based upon values of one or more model parameters of the plurality of model parameters; and
identifying the plurality of distinct subsets as a set of leaf nodes of the tree data structure.

14. The system of claim 13, wherein each leaf node of the set of leaf nodes contains a minimum number of users of the set of users.

15. The system of claim 13, wherein generating the tree data structure comprises:
for each node within the tree data structure, determining whether to generate two or more child nodes of the respective node based upon a mean square error value of a difference of an outcome of a group of users receiving a treatment and an outcome of another group of users receiving a control; and
upon determining to generate the two or more child nodes, generating the two or more child nodes based upon a value of the particular model parameter, wherein each of the two or more child nodes represents a subset of the subset of users assigned to the respective node based upon the value of the particular model parameter associated with the respective child node.

16. The system of claim 11, wherein each distinct subset of the plurality of distinct subsets of the plurality of users is associated with distinct user properties describing at least one of a user profile property and user interaction behavior.

17. The system of claim 11, wherein the objective optimization model is a stochastic optimization model configured to determine probabilities of model parameters for each distinct subset given model constraints.

18. The system of claim 11, wherein identifying the one or more model parameters of the plurality of model parameters to be applied to said each second user, comprises:
determining that a particular model parameter of the plurality of model parameters has an associated probability of the plurality of probabilities that is above a probability threshold; and
assigning, to said each second user, the particular model parameter based upon the associated probability being above the probability threshold.

19. The system of claim 11, wherein identifying one or more model parameters of the plurality of model parameters to be applied to said each second user, comprises:
determining that probabilities associated with each of the plurality of model parameters is below a probability threshold; and
assigning, to said each second user, a subset of model parameters of the plurality of model parameters, wherein each model parameter of the subset of model parameters is above a minimum probability threshold.

20. The system of claim 11, wherein the one or more model parameters of the plurality of model parameters to be applied to said each user is related to configuring thresholds of at least one of: frequency of notification delivery or selection of feed content.
